(19) United States
(12) Patent Application Publication
(10) Pub. No.: US 2009/0165007 A1
(43) Pub. Date: Jun. 25, 2009

(54) TASK-LEVEL THREAD SCHEDULING AND RESOURCE ALLOCATION

(75) Inventor: Souren Aghajanyan, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/959,464

(22) Filed: Dec. 19, 2007

(51) Int. Cl. G06F 9/46

(52) U.S. Cl. 718/103; 718/100

(57) ABSTRACT

Task schedulers endeavor to share computing resources, such as the CPU, among many threads. However, the task scheduler may be unable to identify the resources that will be utilized by a thread, and may allocate resources inefficiently due to incorrect predictions of resource utility. Task scheduling may be improved by identifying the rate determining factors for various thread tasks comprising a thread, e.g., a first task that is rate-limited by a communications bus, a second task that is rate-limited by the CPU, and a third task that is rate-limited by a communications network. If the instructions are so identified, the operating system may be able to schedule tasks and to allocate resources based on the resources to be utilized by the threads, which may improve efficiency and computing performance.

### BACKGROUND

A key feature of many modern computer systems is multitasking, involving the concurrent execution of many programs comprising one or more threads of execution. Such multitasking commonly involves a task scheduler, which allocates shares (e.g., time slices) of the central processing unit to various threads in turn. Many task schedulers are capable of handling interrupts, in which a thread is permitted to request a larger share of the central processing unit, and of providing preemptive multitasking, in which threads are assigned ordered priorities (e.g., numeric priorities) and the central processing unit is more heavily allocated to higher-priority threads. More recently developed multitasking techniques include the allocation of shares of multiple central processing units, such as in multicore processors having several (e.g., two or four) processing cores that operate in asynchronous parallel to provide processing resources to a potentially large and diverse set of threads of execution.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

This disclosure presents task scheduling techniques at a thread task level. A thread of execution may accomplish a particular operation by performing a set of tasks, which may be performed in series in various forms, e.g., in a cyclic or loop order, or in a hierarchical order, or in an arbitrary order. Moreover, the nature of each thread task may have rate determinants of different factors. For example, a first task may be rate-determined by the central processing unit, such that the allocation of more shares of a processor will more quickly complete the task. A second task may be rate-determined by the speed of a communications bus (e.g., in communicating with memory in a set of memory operations, such as memory compaction.) A third task may be rate-determined by the speed of a network connection (e.g., in transferring data over a network.)

The techniques presented herein involve identifying the rate determinants of various thread tasks, such that a task scheduler may schedule the thread tasks according to the availability of the rate determinants. For example, if a thread task is identified as rate-determined by a network connection, then a task scheduler may allocate the scheduling of this thread task based on the availability of the network connection. On the other hand, if a thread task is identified as rate-determined by the central processing unit, then the task scheduler may allocate more shares of the central processing unit to this thread task. This manner of task scheduling based on the rate determinants of various thread tasks may provide a more incisive allocation of computing resources and may yield a more efficient completion of the thread tasks.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a table illustrating some details of thread tasks comprising two threads.

FIG. 2 is a table illustrating a portion of a task schedule for the two threads illustrated in FIG. 1.

FIG. 3 is a table illustrating some details of thread tasks comprising another two threads.

FIG. 4 is a table illustrating a portion of a task schedule for the two threads illustrated in FIG. 3.

FIG. 5 is a flow diagram of an exemplary method of indicating a rate determinant of a thread task.

FIG. 6 is a flow diagram of an exemplary method of assigning a scheduling priority to a thread task in a thread executing on a computer system.

FIG. 7 is an illustration of an exemplary computer-readable medium comprising processor-executable instructions configured to embody the techniques disclosed herein.

FIG. 8 is an illustration of an exemplary source code having rate determinant attributes associated with various programming language constructs containing instructions that are rate-determined by a resource.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Computer systems may be tasked with executing several processes in parallel, where each process comprises one or more threads of execution. For example, a computer system may concurrently handle a word processor application, comprising a user interface thread for displaying the application and handling user input, and a data handling thread for managing access to the word-processor data; a media player application, comprising a user interface thread for displaying the media player window and handling user input, and a media playing thread for rendering increments of the media through multimedia devices; and one or more operating system processes having one or more threads for managing various hardware and software components of the operating environment.

The concurrent processing of various threads is handled by a task scheduler, which allocates shares of the central processing unit to the threads. The task schedulers referred to herein are generally used for scheduling processing time among threads of execution in a computer system, but at least some aspects of this disclosure and the techniques presented herein may relate to other forms of task schedulers. Some simple (“time-slicing”) task schedulers may allocate shares of the central processing unit to all threads in sequence. However, these task schedulers may not distinguish between active threads that can advantageously utilize the central processing unit and passive threads that are awaiting some other event (e.g., through polling), nor between higher-priority processes (e.g., system processes) and lower-priority processes (e.g., background workers), and may yield inefficient computing allocation and reduced system performance. Other task schedulers may preemptively allocate the central processing unit, such that more active or higher-priority threads receive larger shares of processing resources than less active or lower-priority threads.

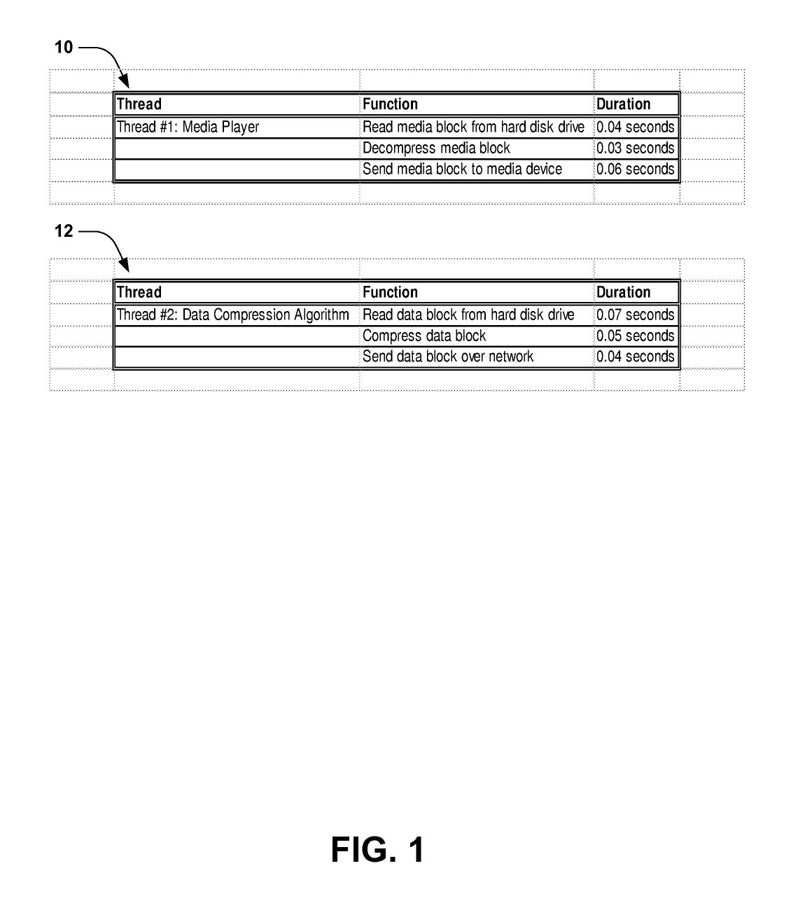

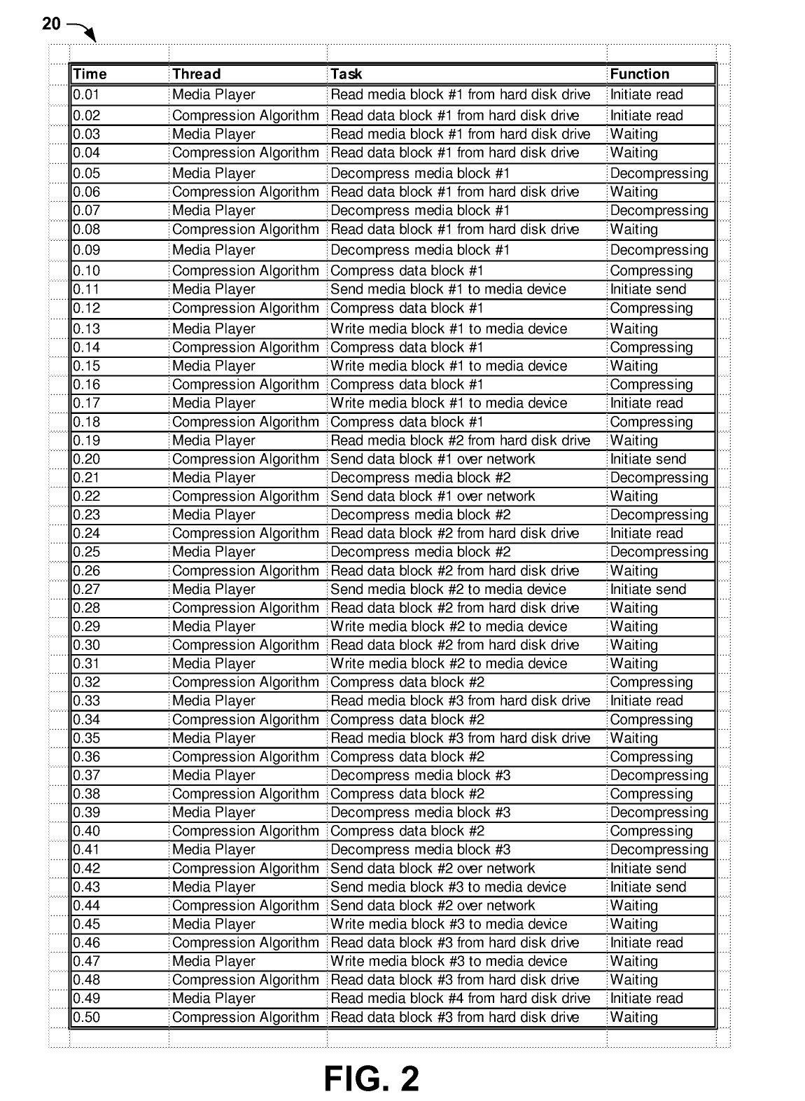

FIGS. 1-2 together present an example of a task scheduler handling two threads of execution in a multitasking environment. It may be appreciated that the example presented herein is highly simplified in many aspects for the purpose of illustration. For instance, the time scales are illustrated in increments of 0.01 seconds, whereas most task schedulers allocate central processing unit shares on a much smaller time scale. Also, the task scheduler allocates processing time only between these two threads, and without any time allocated for system functions or other applications that may concurrently execute. However, the two threads of execution in this example are both active and resource-consuming threads, and both have time-sensitive components (e.g., keeping the media buffer full and sending the data stream over the network) that may confer a comparatively high thread priority. Thus, a computer system may, in fact, devote a large share of computing resources to these two threads.

FIG. 1 defines the threads of execution involved in these examples. The first thread of execution comprises a media player application 10 that incrementally supplies a buffer on a media device (e.g., a sound card) with blocks of media data streamed from a hard disk drive. The media data on the hard disk drive is stored in a compressed manner according to a media codec, which the media player application 10 utilizes to decompress the blocks of media data before sending the uncompressed blocks to the media device. Accordingly, the media player application 10 comprises a loop of three tasks: reading a block of media data from the hard disk drive, which is accomplished in 0.04 seconds; decompressing the media block, which is accomplished in 0.03 seconds; and sending the uncompressed (and potentially much larger) media block to the media device, which is accomplished in 0.06 seconds. The second thread of execution comprises a data compression algorithm 12 that is reading a file stored on the hard disk drive and sending a compressed version out over a computer network (e.g., saving a compressed version to a network file server.) The data compression algorithm 12 is also structured as a loop of three tasks: reading a (comparatively large) block of data from the hard disk drive, which is accomplished in 0.07 seconds; compressing the data block according to a compression technique, which is accomplished in 0.05 seconds; and sending the compressed data block over the network, which is accomplished in 0.04 seconds. Again, it may be appreciated that the times and mechanisms provided herein are simplified for the purpose of illustration.

The media player application 10 and the data compression algorithm 12 are both very active applications, and both involve steady consumption of computing resources, including central processing unit power. A preemptive task scheduler may therefore attempt to facilitate the processing of these applications by allocating a significant amount of computing resources to the respective threads of execution. Moreover, because the threads are both user-level applications, the threads are likely to have the same thread priority, so neither thread may preempt the other thread. As a result, the computing resources are likely to be evenly distributed during the phases of these applications that involve significant central processing unit utilization.

FIG. 2 illustrates an exemplary task schedule 20 for sharing computing resources between the media player application 10 and the data compression algorithm 12. The preemptive task scheduler that handles these threads is configured to allocate shares of the central processing unit in 0.01 second increments, and because both threads are utilizing significant computing resources and are of the same priority, the task scheduler alternates the central processing unit shares between the threads. In this exemplary task schedule 20, the media player thread begins by initiating a read of a media block from the hard disk drive, and the compression algorithm begins by initiating a read of a data block from the hard drive. Both threads now wait for the read operation to complete, but the task scheduler continues to allocate computing cycles to the threads due to their active status and comparatively high thread priorities. At 0.05 seconds, the read operation for the media player thread completes, and the media player begins decompressing the media data block according to the media codec. However, the decompression is interleaved with the processing cycles allocated to the compression algorithm thread, which are still spent waiting for the read operation of the larger data segment to complete. Conversely, at 0.10 seconds, the compression algorithm completes its read operation and begins compressing data, but the compression is interleaved with computing cycles allocated to the media player, which initiates the sending of the decompressed media block to the media device (e.g., writing the media block to the buffer of the media device) and then waits for the sending to complete.

As a result of the frequent wait cycles involved in these algorithms while input/output operations are performed, the task schedule 20 of FIG. 2 produces some inefficiencies in allocating computing resources to the threads of execution for the media player application 10 and the data compression algorithm 12. In particular, of the fifty time segments that may be allocated to these threads, nineteen time segments are allocated to threads during a wait state. Also, during the period of 0.12 seconds to 0.16 seconds, the central processing unit diverts some central processing unit time away from the data compression algorithm 12, which is able to utilize the central processing unit in performing meaningful work, to the media player application 10, which is occupying a wait state. This inefficient diversion introduces a delay in the processing of the compressed media block without accomplishing any other productive work. Additionally, while not apparent from the example of FIG. 2, a further problem with this task schedule 20 is the frequent context switching between threads, which imposes a context switch delay during the saving and restoring of the contexts of the threads. Where the task schedule 20 includes unnecessarily switches context to a waiting thread and back again, the time and resources involved in the two context switching are inefficiently allocated away from processing (e.g., compression and decompression steps) that could otherwise be performed.

While this problem may resemble the recognized inefficiencies of time-slicing task schedulers, the cause of the inefficiencies in this task schedule 20 is significantly different. Time-slicing task schedulers suffer from low performance by remaining insensitive to the comparative priorities of the threads, and by failing to reallocate resources during long thread wait states. By contrast, in this example, the tasks involved in each thread cycle very quickly between central processing unit intensive tasks and tasks involving short-term wait operations, e.g., memory, network, and storage device accesses. Such alternation between central processing unit usage and short-term wait operations may be quite common for many applications. A preemptive task scheduler may be capable of detecting a wait state in a thread, but it may be more difficult for the task scheduler to determine why such a rapidly cycling thread is waiting at a particular instant, and therefore whether allocating processing time is likely to generate significant progress in the thread. For instance, a preemptive task scheduler may endeavor to induce a wait state for any instruction involving a memory, storage, or network access. However, the preemptive task scheduler cannot predict whether the wait state will be short (e.g., where only a small amount of data is to be read via a high-performance bus, or where a memory access can be read from a local cache) or long (e.g., where a significant amount of data is to be read from a low-bandwidth device, or where a network access involves high latency.) Accordingly, task schedulers that attempt to detect waiting based on the nature of the executing instructions may be unable to produce significant efficiency gains. Moreover, a very sensitive preemptive task scheduler that acutely analyzes the status of various threads and makes adjustments may actually diminish performance; the acute analysis might be unable to produce significant efficiency gains, yet may induce additional inefficiencies by diverting computing resources, including central processing unit time segments, away from threads that are performing useful work.

Accordingly, the inefficiency evident in the task schedule 20 of FIG. 2 may be difficult to improve via the task scheduler. However, the inefficiency could be addressed in other ways. As noted previously, various types of computing tasks are likely to be rate-determined by different factors; some may be limited by the communication speed, latency, or processing time of external components (such as a system bus), while others may be rate-determined only by the speed of the central processing unit. Again, the task scheduler may be unable to predict the rate determinants of an instruction or an instruction block, i.e., whether an instruction is likely to induce a short wait or a long wait that justifies a temporary de-prioritization of the thread. However, and as one example, the programmer of an instruction may have a more accurate idea of the nature of the interaction and the likely source of delay in performing it, e.g., whether an operation on an object stored in memory is likely to be long-term (and therefore rate-determined by the communications bus) or short-term (and therefore rate-determined more significantly by the speed of the central processing unit.) The programmer may therefore be able to identify the likely rate determinant(s) of an instruction or an instruction block, such as by attaching a rate determinant attribute to a block of instructions that the task scheduler may later use to make task-scheduling determinations. (“Rate-determinant attribute,” as used herein, indicates some form of token or identifier associating with a block of instructions comprising a thread task with a rate determinant, wherein the attribute indicates the rate determinant(s) for a thread executing the thread task.)

As a second example, a compiler may be able to identify the rate determinant of an instruction in the context of the preceding operations (e.g., whether an object accessed in memory was recently accessed by a previous instruction, which may increase the probability of caching that reduces the memory access as a rate determinant.) The compiler may therefore be able to determine the likely rate determinant for a block of instructions, and may be able to specify the rate determinant of the instruction block for use during task scheduling. The compiler may be capable of more accurate predictions than the task scheduler because the compiler isn't compelled to make a rapid determination, and because the compiler can utilize the context of the instruction block in view of the preceding instructions and the operating context of the instruction block.

Accordingly, this disclosure presents some techniques for specifying one or more likely rate determinants for a particular computing task that may be operating within a thread (referred to herein as a “thread task”), and for making task scheduling determinations based on the rate determinant information. By providing such information and utilizing such information for task scheduling, a computer system may be able to reduce some inefficiencies of less informed task scheduling techniques, and may therefore improve the allocation of computing resources among threads performing various types of tasks.

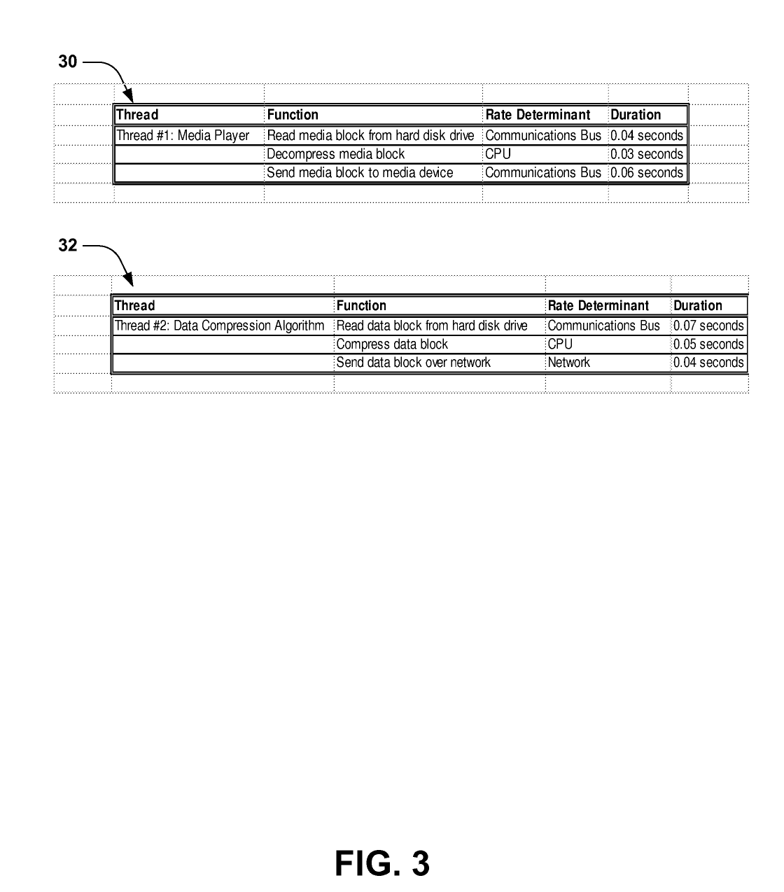

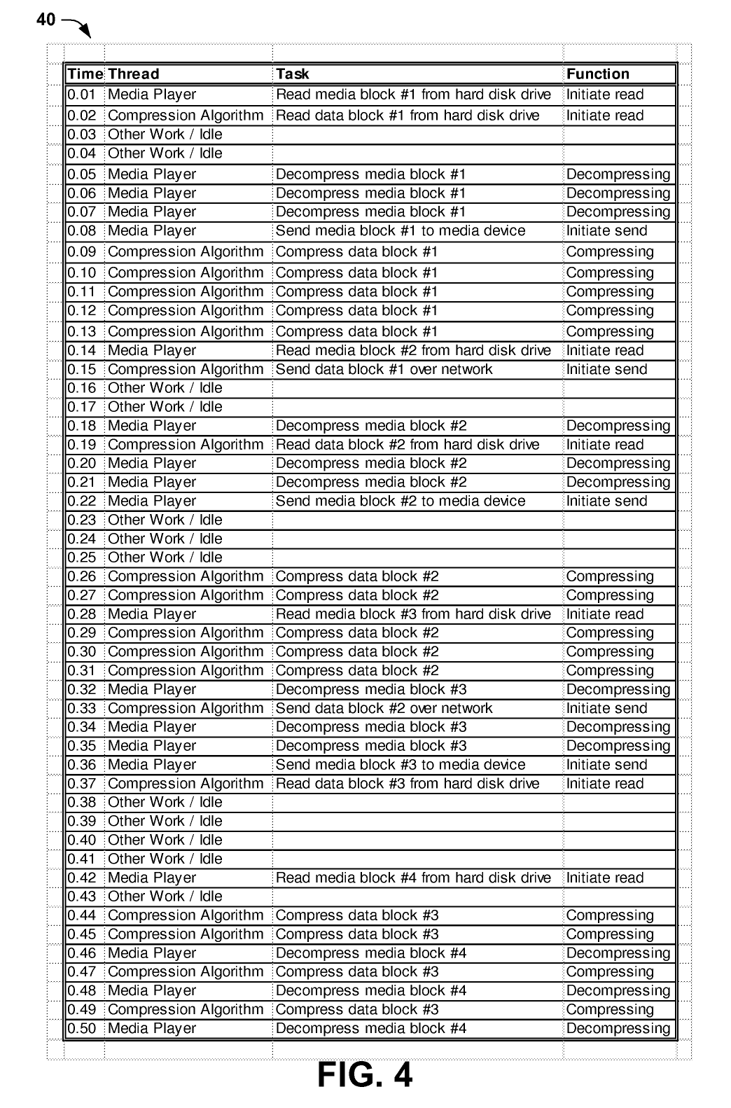

FIGS. 3-4 illustrate an example of an improved task schedule 40 in accordance with these principles. This improved task schedule 40 again pertains to the media player application 10 and the data compression algorithm 12 illustrated in FIG. 1 and handled by a less efficient task scheduler in FIG. 2. However, in this example and as illustrated in FIG. 3, the media player application 30 and the data compression algorithm 32 include information identifying the rate determinants of various portions of the algorithms. For instance, for the media player application 30, the first thread task and the third thread task are rate-determined by the communications bus, while the second thread task is rate-determined only by the central processing unit. Similarly, for the data compression algorithm 32, the first thread task is rate-determined by the communications bus, the second thread task is rate-determined by the central processing unit, and the third thread task is rate-determined by the speed of the network.

In view of the rate determinant information included in the algorithms, an improved task schedule 40 may be devised, such as shown in FIG. 4, that allocates resources (in particular, the central processing unit) according to the rate-determining factors of the current thread task of each thread. For instance, both the media player application 30 and the data compression algorithm 32 again begin with a lengthy read from the hard disk drive. These operations are identified as being rate-determined by the communications bus, such that allocating extensive blocks of central processing unit resource are unlikely to yield significant progress. Accordingly, the task scheduler may allocate these central processing unit cycles to other work, such as other threads or operating environment maintenance tasks (e.g., memory compaction), or may allocate these cycles as idle, which may produce a small amount of power conservation. (It may be appreciated that the task scheduler in this example does not suspend these threads or starve them of central processing unit cycles. Rather, the task schedule 40 omits these threads from the period of 0.03 seconds to 0.05 seconds only to indicate that extensive, dedicated segments of central processing unit time are not granted to these threads. The threads may still be granted small central processing unit time segments, but are temporarily de-prioritized during the performance of the tasks that are rate-determined by other factors, such as the speed of the communications bus.)

One the thread tasks that are rate-determined by the communications bus are complete, both the media player application 30 and the data compression algorithm 32 move on to tasks that are rate-determined by the central processing unit (at 0.05 seconds and 0.09 seconds, respectively.) In response, the task scheduler re-prioritizes each thread upon initiating the thread tasks that are rate-determined by the central processing unit, and allocates significant shares of the central processing unit to the threads during the performance of these tasks. Conversely, upon completion of the compression and decompression thread tasks, the media player application 30 proceeds (at 0.08 seconds) to another task that is rate-determined by the communications bus, and the data compression algorithm 32 proceeds (at 0.15 seconds) to a task that is rate-determined by the network communications rate, and the task scheduler again temporarily de-prioritizes these threads and spends spare cycles on other tasks or in an idle state.

The improved task schedule 40 of FIG. 4 illustrates some efficiency gains as compared with the task schedule 20 of FIG. 2, even within these limited examples and short time spans. As one example, in contrast with the task schedule 20 of FIG. 2 that allocates nineteen central processing unit time segments to threads that are occupying a wait state, the improved task schedule 40 of FIG. 4 allocates twelve central processing unit time segments to other work or to idleness. As another example, in contrast with the time period of FIG. 2 between 0.12 seconds and 0.16 seconds illustrating an unproductive diversion of central processing unit time segments away from the data compression algorithm during a central-processing-unit rate-determined phase, the improved task schedule 40 of FIG. 4 illustrates a more efficient allocation of resources, e.g., between the periods of 0.08 seconds and 0.14 seconds, where the central processing unit may be more heavily allocated to the data compression algorithm during a central-processing-unit rate-determined phase. This improvement leads to greater progress in the processing of the threads, as illustrated by the progress accomplished by each thread in the same time span. Whereas the task schedule of FIG. 2 accomplishes the processing of approximately 4.1 media blocks by the media player application 10 and 2.3 data blocks by the data compression algorithm 12, the improved task schedule of FIG. 4 accomplishes the processing of approximately 4.7 media blocks by the media player application 30 and 2.6 data blocks by the data compression algorithm 32. As a third example, the improved task schedule 40 of FIG. 4 reduces the incidence of unnecessary context switches to and from thread tasks that are occupying a short-term wait state.

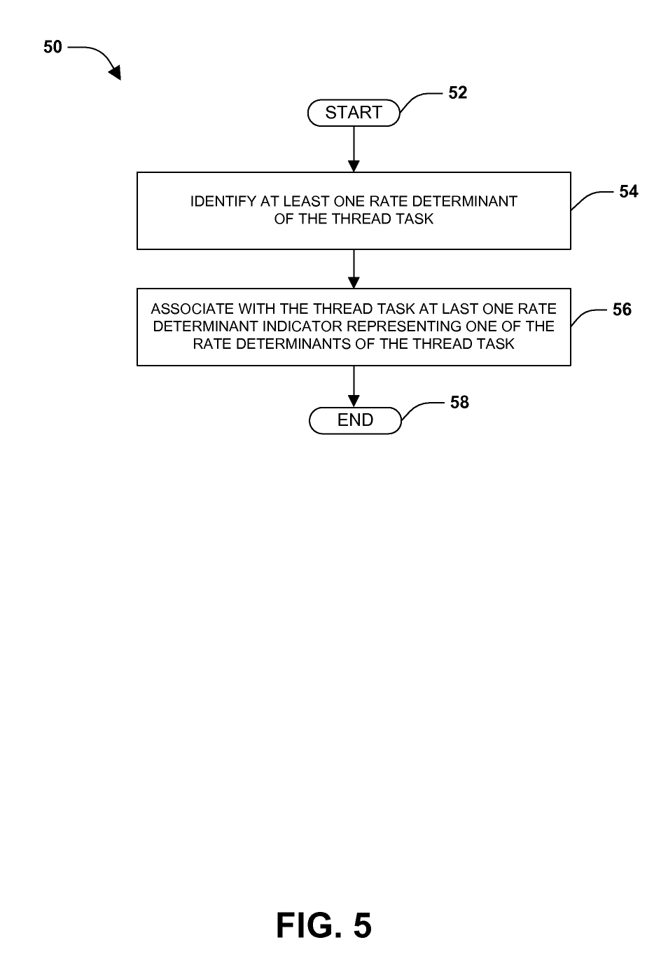

The techniques described herein and illustrated in the contrasting examples of FIG. 2 and FIG. 4 involve the designation of rate determinants for various thread tasks within various threads of execution. FIG. 5 illustrates one embodiment in accordance with these techniques, comprising a flow diagram of an exemplary method 50 of indicating a rate determinant of a thread task. The exemplary method 50 begins at 52 and involves identifying at least one rate determinant of the thread task 54. It may be noted that some thread tasks may be rate-determined by more than one rate determinant; for example, a thread task may involve a data copy operation between two devices (each comprising a rate determinant) communicating over a communications bus (comprising a third rate determinant.) The exemplary method 50 also involves associating with the thread task at least one rate determinant indicator representing one of the rate determinants of the thread task 56. (As used herein, “rate determinant indicator” indicates some form of token or identifier associating a particular rate determinant with a thread task.) Having determined a rate determinant for the thread task and having specified the rate determinant associated with the thread task, the exemplary method 50 therefore succeeds in indicating the rate determinant of the thread task, and so ends at 58.

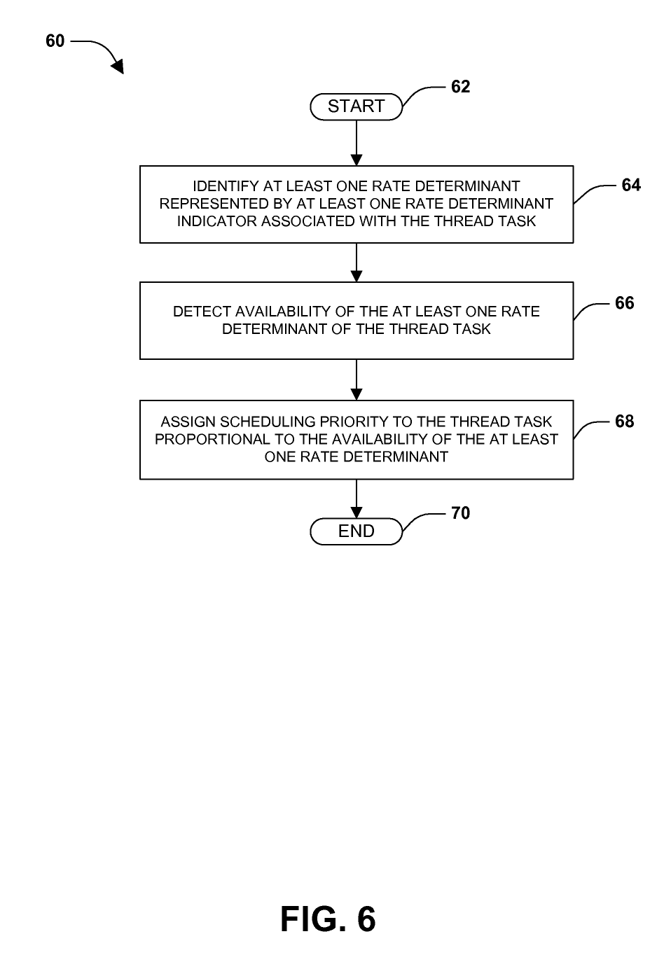

The techniques described herein also relate to task scheduling techniques that include a consideration of the rate determinants of the thread tasks currently performed by the threads to be scheduled. FIG. 6 illustrates one embodiment in accordance with these techniques, comprising a flow diagram of an exemplary method 60 of assigning a scheduling priority to a thread task in a thread executing on a computer system. The exemplary method 60 begins at 62 and involves identifying at least one rate determinant represented by at least one rate determinant indicator associated with the thread task 64. The exemplary method 60 also involves detecting availability of the at least one rate determinant of the thread task 66. The exemplary method 60 also involves assigning the scheduling priority to the thread proportional to the availability of the at least one rate determinant 68. Having identified a rate determinant for the thread task and having assigned priority to the thread in view of the availability of the rate determinant, the exemplary method 60 thereby accomplishes the task scheduling of the thread task based on the rate determinant, and so ends at 70.

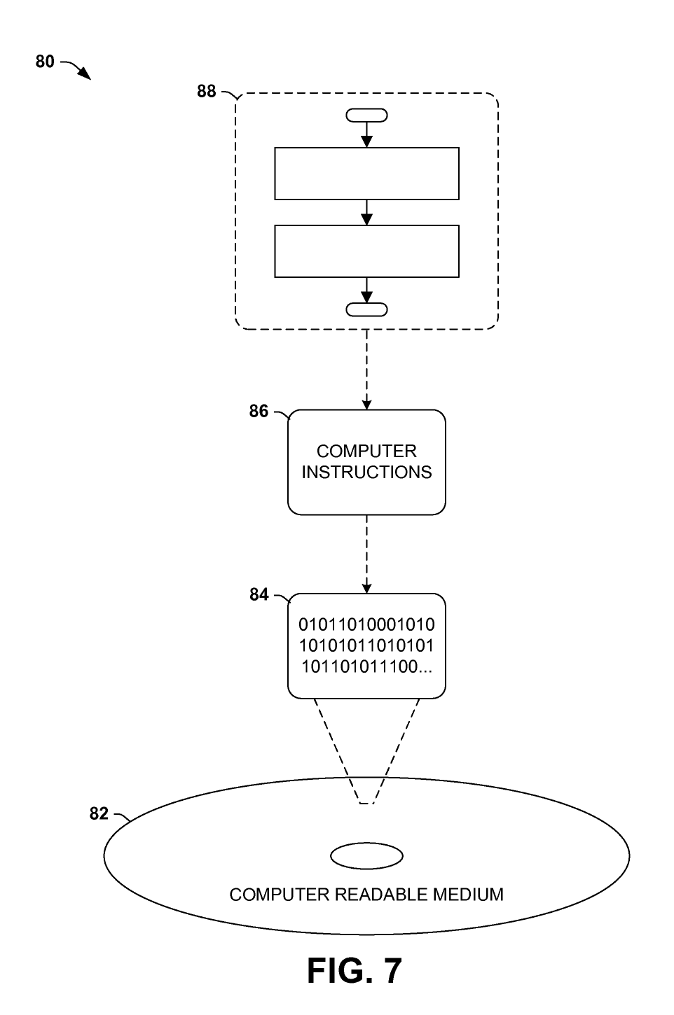

Still another embodiment involves a computer-readable medium comprising processor-executable instructions configured to apply the techniques presented herein. An exemplary computer-readable medium that may be devised in these ways is illustrated in FIG. 7, wherein the implementation 80 comprises a computer-readable medium 82 (e.g., a CD-R, DVD-R, or a platter of a hard disk drive), on which is encoded computer-readable data 84. This computer-readable data 84 in turn comprises a set of computer instructions 86 configured to operate according to the principles set forth herein. In one such embodiment, the processor-executable instructions 86 may be configured to perform a method of indicating a rate determinant of a thread task, such as the exemplary method 50 of FIG. 5. In another such embodiment, the processor-executable instructions 86 may be configured to perform a method of assigning a scheduling priority to a thread task in a thread executing on a computer system, such as the exemplary system 60 of FIG. 6. Many such computer-readable media may be devised by those of ordinary skill in the art that are configured to operate in accordance with the techniques presented herein.

Many aspects of the techniques described herein may be devised with many variations by those of ordinary skill in the art while implementing the techniques described herein. Such variations may be available for aspects of both the techniques for identifying rate determinants for various thread tasks, and the techniques for scheduling threads and providing resources thereto in view of the identified rate determinants of the thread tasks. Moreover, some variations of such aspects may present additional advantages and/or reduce disadvantages with respect to other variations of these and other techniques.

A first aspect that may vary among embodiments of these techniques relates to the types of rate determinants that may be identified for a thread task. In the context of task scheduling, it may be particularly helpful to determine whether a thread task is significantly rate-determined by a central processing unit; this determination may inform the task scheduler as to whether or not to allocate significant central processing unit time segments to a thread task. However, other rate determinants may be identified for a thread task, where the identification of such rate determinants may facilitate the allocation of the resources represented by a thread task. For example, two applications may share a network resource: a network streaming media application, which significantly depends on a steady throughput of network data, and a high-performance computation application (e.g., a complex mathematics processor) that only uses the network to send progress updates to a network log. The network streaming media application (in particular, the media buffering component thereof) is rate-determined by the network, because most of the computing work involves requesting and receiving new data; by contrast, the high-performance computation application is rate-determined on the central processing unit(s), and its network usage does not significantly determine its rate of progress. Accordingly, the thread tasks comprising the network streaming media application may be associated with a communications network rate determinant indicator, while the thread tasks comprising the high-performance computation application may be associated with a central processing unit rate determinant indicator. The task scheduler may therefore prioritize the high-performance computation application, while the network communication device may prioritize the network streaming media application for network communication.

Other types of rate determinants may also be advantageously associated with thread tasks. For instance, a graphics processing unit may be identified as a rate-determinant (e.g., such that a high-detail 3D application running in a window may be prioritized for graphics resources over a relatively static dialog window.) Other advantageous rate determinants include a communications bus (e.g., the data compression algorithm that cannot perform any compression or decompression work until a data block is read from a hard disk drive may be prioritized over a thread that writes files to the hard disk drive in the background); a device, such as a peripheral input or output device (e.g., an application that is unable to proceed without user input may be prioritized over an application that autonomously performs meaningful work but may be altered by user input); and a second thread task (e.g., an application is blocked in order to synchronize with a task being performed by the second thread may be prioritized over an application that is configured simply to monitor the progress of the second thread.) Still other types of rate determinants may be devised and included in the set of rate determinants that may be associated with various thread tasks. However, it may be detrimental to identify too many types of rate determinants, because the process of identifying and reacting to identified rate determinants of various threads may become so complex as to introduce some inefficiencies.

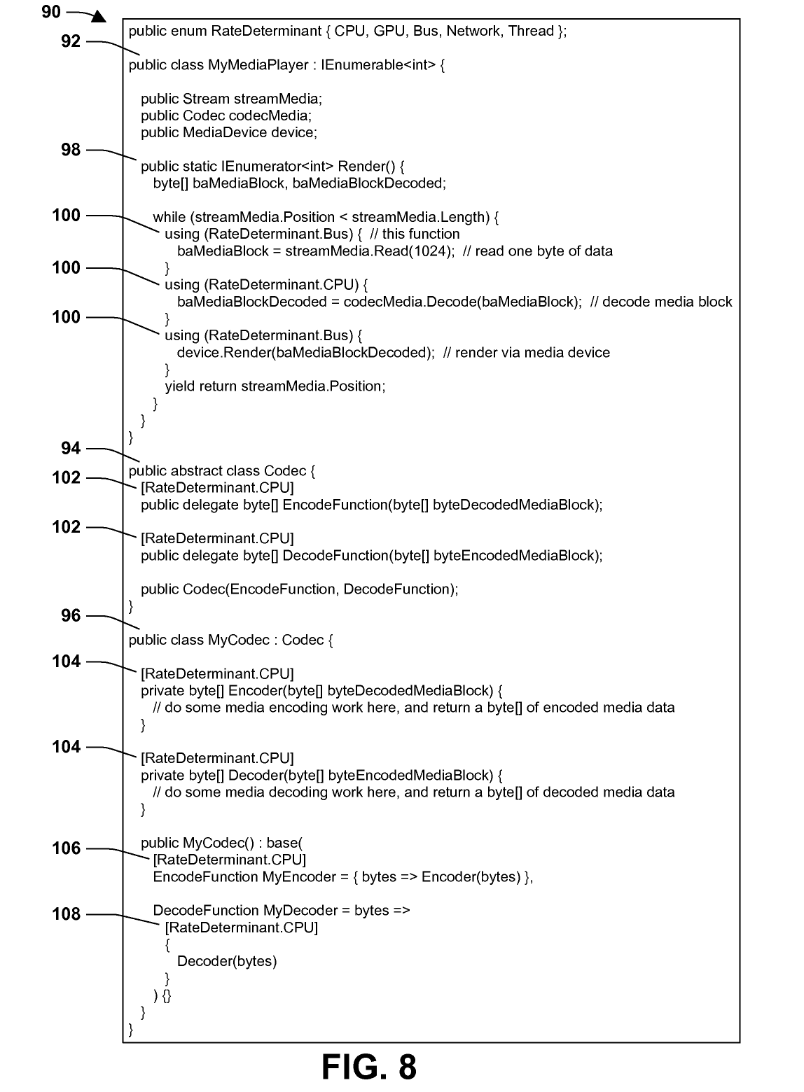

A second aspect that may vary among embodiments of these techniques relates to the manner of identifying a thread task as associated with a particular rate determinant. FIG. 8 illustrates one example of such an identification by a programmer of some rate determinants of various instruction blocks within an exemplary source code 90. It will be appreciated that, while the source code provided in FIG. 8 is modeled after a generic object-oriented programming language, the techniques illustrated thereby are not limited to any particular programming language or paradigm, or to any system architecture. Rather, the source code is provided as an exemplary representation of how rate determinants may be associated with some blocks of instructions grouped according to various programming language constructs while representing a thread task. Any instructions that may be created or annotated by a programmer or other user may be so associated with rate determinants.

The exemplary source code 90 of FIG. 8 illustrates some techniques for specifying rate determinants within various source code blocks, such as a function, a portion of a function, a function delegate, a lambda expression, and a portion of an expression tree. The exemplary source code 90 represents a framework for some components comprising a media player application, including a media player class 92 called “MyMediaPlayer,” an abstract media codec class 94 called “Codec,” and an implemented media codec class 96 called “MyCodec” that derives from the abstract media codec class 94 and comprising an implementation of a media codec. The media player class 92 provides a framework for implementing a Render method 98, comprising a loop of the same three tasks associated with the media player application 10 of FIG. 1 and the media player application 30 of FIG. 3. The loop continues until the Render method 98 determines that the media stream provided to the instance of the media player class 92 has reached the end of the stream (i.e., where the current position in the media stream equals the length of the media stream.) The loop comprises a media stream read, a media stream decoding according to a provided codec, and a media stream rendering through a media device (such as a sound card.)

In this example 90, the three instructions comprising the worker-thread loop within the Render method 98 represent three different thread tasks, each of which has a particular rate determinant: the media stream read and the rendering are rate-determined by the communications bus of the system, and the decoding is rate-determined by the central processing unit. Accordingly, these portions of the Render method 98 of the media player class 92 are identified with rate determinant attributes 100, comprising a “using” statement specifying the type of rate determinant (which may be specified, e.g., as a selection among an enumeration, such as the RateDeterminant enumeration included in this exemplary source code 90.) These rate determinant attributes 100 may be included in the compiled code of the media player application, and the thread executing the media player application may (e.g.) alter its rate determinant status based on the attributes associated with the thread task currently being executed by the thread. These rate determinant attributes 100 may additionally be evaluated as synchronization mechanisms, i.e., as requests for a share of the resource comprising the rate determinant. For example, in addition to indicating that the various thread tasks are rate-dependent on these resources, these rate determinant attributes 100 may be interpreted as requests to suspend the processing of the thread altogether if a share of the resource is unavailable, and to unsuspend the thread task once a share of the resource later becomes available.

FIG. 8 also illustrates some other types of source code blocks that may also be associated with rate determinant attributes. For example, the abstract media codec class 94 includes a couple of delegates called “EncodeFunction” and “DecodeFunction” that are to be implemented in derivations of the abstract base class. Because such functions typically involve intensive computation, the abstract media codec class 94 includes rate determinant attributes 102 identifying any such functions as rate-determined by the central processing unit. Similarly, the implemented media codec class 96 includes “Encoder” and “Decoder” methods for the delegated functions; for the same reason as with the delegates, this implemented media codec class 96 includes rate determinate attributes 104 identifying the “Encoder” and “Decoder” functions as rate-determined by the central processing unit. Some further aspects of the exemplary source code 90 of FIG. 8 illustrate that the inclusion of rate determinant attributes is not limited to imperative and/or object-oriented programming paradigms. For example, the constructor for the implemented media codec class 96 specifies a lambda expression named “MyEncoder” that is associated with a rate determinant attribute 106 that (again) specifies the codec encoding as rate-determined by the central processing unit, and a lambda expression named “MyDecoder” that encapsulates the Decoder function within an expression tree, where a portion of the expression tree is associated with a rate determinant attribute 108. Other types of programming language constructs comprising instruction blocks that are rate-determined by a particular resource may be associated with rate determinant attributes in accordance with the techniques discussed herein.

The association of instruction blocks with various rate determinants, and the generation of rate determinant attributes associated with such instruction blocks and indicating same, may also be performed by various types of automated methods. As one example, the identification may be made (and the association may be performed) by an integrated development environment, such as a programming environment that analyzes instructions received by a programmer and logically determines the rate determinants of various blocks of instructions. The identification may also be made by a compiler, which may perform a similar analysis and may include supplemental instructions or metadata, such as in an assembly manifest, comprising rate determinant attributes associated with various instruction blocks. These automated techniques may be more capable of making such identifications than a task scheduler, because such integrated development environments and compilers may function on a less time-sensitive nature than a task scheduler, and also because these components may benefit from a more direct analysis of the instructions preceding and following the invocation of the instruction block (i.e., the operating context of the instruction block, which may indicate its likely rate determinant.)

Still other components may be capable of identifying the rate determinants of various instruction blocks during the operation of the thread tasks. As one example, a code profiler may be utilized to monitor the flow of execution through the compiled application, and to identify rate determinants of various instruction blocks comprising various thread tasks. Alternatively or additionally, a resource monitor may be utilized to monitor the resources accessed by the thread during the performance of various instruction blocks comprising various thread tasks (e.g., by monitoring the usage of the central processing unit during the execution of an instruction block.) Hence, the identification may be performed by analyzing the causes of the rate determination (i.e., the instructions performed by the thread task) and/or by the effects of the rate determination (i.e., the particular resources used while performing the instructions.) Many such techniques for identifying rate determinants of various thread tasks may be devised by those of ordinary skill in the art while implementing the techniques discussed herein.

A third aspect that may vary among embodiments of these techniques relates to the manner of associating rate determinants with various thread tasks. As one example, such as described in the example of FIG. 8, the rate determinants may be identified by including attributes in the source code, and/or by including supplemental instructions inline with the instructions comprising the thread task (e.g., “first set the rate determinant of the thread to ‘CPU’, then perform this thread task, then clear the rate determinant of the thread”), and/or by including indicators in an assembly manifest identifying a rate determinant for an instruction block (e.g., “the function ‘EncodeFunction’ is associated with a central processing unit rate determinant”), etc. A thread task may also be associated with more than one rate determinant where the execution is determined by two or more resources (e.g., a file-copy thread task my be rate-determined by two storage devices cooperating over a communications bus.) As another example, components that identify a rate determinant of a thread task during a first performance of a thread task may be advantageously configured to store one or more rate determinant indicators associated with the thread task (e.g., with an address range comprising the binary instructions in the compiled application for performing the thread task) as determined during the first performance of the thread task. Upon a subsequent invocation of the thread task (e.g., upon execution of the instructions of the same code block), the computer system may identify the rate determinants of the thread task by retrieving the stored rate determinant indicators associated with the thread task. Many such techniques for associating rate determinants (such as through rate determinant indicators) with thread tasks may be devised by those of ordinary skill in the art while implementing the techniques provided herein.

A fourth aspect that may vary among embodiments relates to the utilization of the rate determinant information (e.g., rate determinant identifiers associated with thread tasks, and rate determinant attributes associated with instruction blocks comprising task threads.) Computer systems may advantageously utilize this information in many ways. As one example, a task scheduler may allocate shares of a central processing unit in view of whether an executing thread task is rate-determined by the central processing unit. If the thread task is not rate-determined by the central processing unit, the task scheduler may allocate only a small segment of processing time to prevent the thread from starving or becoming suspended. For instance, if a thread task is receiving a file from a network and is rate-determined by the network, the task scheduler may allocate for the thread task a small amount of processing time, so that the thread task can determine whether the file transfer is complete and monitor the status of a download buffer. However, if the central processing unit is a rate determinant for the thread task, then the task scheduler may allocate more processing time for the thread task in order to achieve improved performance.

Some additional techniques may be advantageous for allocating shares of a processing unit (such as a central processing unit or a graphics processing unit) to thread tasks that are rate-determined by such processing units. As one example, in a multiprocessing system, such as a multiprocessor or a multicore environment, a thread task that is rate-determined by such processing units may be assigned an affinity of a processor for the thread task, such that the thread task is preferentially run on a particular processor or processor core. This technique may improve the utilization of a processor memory cache (e.g., by improving the odds that memory accessed by the thread task will remain in the cache) and/or reduce the incidence of context-switching (e.g., by dedicating an unallocated processor to the thread task for uninterrupted performance.) As another example, a task scheduler that identifies a thread task as rate-dependent on a processor may endeavor to provide more contiguous shares of the processor for the thread task, thereby permitting the thread task to run on the processor for longer periods without interruption, which may also improve cache utilization and reduce the incidence of context switching.

More generally, a computer system may utilize a rate determinant with which a thread task is associated in order to manage the allocation of resources shared by many such threads. When a component of such a computer system (e.g., a resource manager) determines that a thread task is rate-determined by a particular resource, such as a communications network, a graphics processor, or a device such as a tape backup system, the resource manager may query the resource for an unallocated resource share (e.g., a portion of the bandwidth of a network connection.) Upon identifying a free share of the resource, the resource manager may allocate the resource share to the thread task that is rate-determined by the resource. As with the allocation of processing time, if a thread task utilizes a resource but is not identified as being rate-determined by the resource, the resource manager may still allocate a smaller share of the resource to the thread task, but may reserve other shares of the resource for use by thread tasks that may be rate-dependent on the resource. Additionally, upon detecting the completion, failure, or user termination of a thread task to which a share of a resource has been allocated, the resource manager may deallocate the resource share allocated to the thread task.

Another variation of these resource management techniques pertains to techniques for handling a failure to identify a share of a resource that comprises a rate determinant for a thread task. For example, a thread task may be rate-dependent on a communications network, but the resource manager may have allocated all shares (i.e., all of the bandwidth) of the communications network to one or more other thread tasks that are also rate-dependent on the communications network. In this scenario, the resource manager may attempt to redistribute the allocated shares of the resource among the rate-dependent thread tasks to reclaim some shares that may be allocated to the new thread task that is rate-dependent on the resource. This technique may permit the operation of many resource-dependent thread tasks in parallel, but the parallel accesses may cause inefficiency in the use of the resource. For example, if seven thread tasks are simultaneously accessing a hard disk drive, the hard disk drive controller may spend a great deal of time jumping to various sectors of the hard disk platter in order to read or write small amounts of data, and the frequent hard drive head relocations may create additional inefficiency in the form of reduced data throughput.

An alternative technique for handling unavailable shares of a rate-determining resource involves suspending the thread task to which a share cannot be allocated. The suspension of the thread task may be temporary, and perhaps short-term, and may permit some or all of the thread tasks to which the resource is allocated to complete, so that some allocated shares of the resource may be reclaimed by the resource manager. Upon subsequently detecting availability of an unallocated resource share of the resource, the computer system may unsuspend a suspended thread task that is rate-determined by the resource, and may allocate one or more of the unallocated resource shares to the unsuspended thread task. This technique induces a delay in the performance of the suspended thread task, which may starve for lack of resources (e.g., a protracted suspension of a thread task that is rate-determined by an otherwise allocated communications network may end up causing a timeout and the closing of a connection between the suspended thread and a remote server.) However, this technique may achieve an overall more efficient allocation of the shared resource by reducing the amount of context-switching to be performed by the resource. As an intermediate alternative, various thread tasks that are rate-dependent on a resource with limited availability of unallocated shares may be granted temporary allocations of such shares, such that a thread task awaiting a share of a rate-determining resource may be unsuspended, allocated some shares of the resource for a short time, and resuspended, whereupon the shares of the resource allocated to the thread task may be temporarily allocated to the next suspended thread task that is rate-dependent on the same resource. This technique may permit some limited sharing of a heavily allocated resource in order to reduce the incidence of starvation among the suspended thread tasks that are rate-determined by the shared resource. Many variations may be devised in the management of suspended thread tasks due to the unavailability of a rate-determining resource may be devised of those in ordinary skill in the art while implementing the techniques discussed herein.

An additional variation of this technique involves the association of a suspended thread task queue with the resource that is configured to hold references to the threads that have been suspended pending access to the resource. In this variation, upon determining an unavailability of shares of a resource by which a thread task may be rate-determined, and upon suspending the thread task pending the subsequent availability of shares of the resource, the computer system may place the thread task in the suspended thread task queue that is associated with the resource. The computer system therefore forms a set of thread tasks that are waiting on the completely allocated resource, such that when one or more shares become available (e.g., when a thread task utilizing the resource completes, fails, or is terminated by the user), the computer system may unsuspend a suspended thread task within the suspended thread task queue associated with the resource and remove the unsuspended thread task form the suspended thread task queue, while also allocating at least one share of the rate-determining resource to the newly unsuspended thread task. The selection of a thread task from the suspended thread task queue may be performed in many manners, such as on a first-in-first-out (FIFO) basis.

As a further refinement of the queuing of suspended thread tasks associated with a rate-determining resource, the suspended thread task queue may comprise a priority queue, such as a heap, based on an ordered priority indicator that is used to order the selection of suspended thread tasks from the suspended thread task priority queue. For instance, where the thread tasks are hosted by threads having ordered priorities (e.g., numeric priorities where higher numbers indicate higher thread priority), the priority queue may be structured such that the thread task associated with the highest priority among all such threads is selected first for unsuspending when a share of the rate-determining resource becomes available. Many other techniques for suspending and unsuspending thread tasks in response to the dynamic availability of a rate-determining resource may be devised by those of ordinary skill in the art while implementing the techniques provided herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it may be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of indicating a rate determinant of a thread task, the method comprising:
identifying at least one rate determinant of the thread task, and
associating with the thread task at least one rate determinant indicator representing one of the rate determinants of the thread task.

2. The method of claim 1, the at least one rate determinant comprising at least one of a central processing unit, a graphics processing unit, a communications bus, a communications network, a device, and a second thread task.

3. The method of claim 1, the identifying comprising: identifying at least one rate determinant attribute associated with an instruction block of the thread task.

4. The method of claim 3, the instruction block comprising a source code block comprising at least one of a function, a portion of a function, a function delegate, a lambda expression, and a portion of an expression tree.

5. The method of claim 3, the rate determinant attribute specified for the instruction block by at least one of a software developer, an integrated development environment, and a compiler.

6. The method of claim 3, the rate determinant attribute comprising a request for a share of a resource comprising the rate determinant.

7. The method of claim 1, the identifying comprising: profiling at least one instruction of the thread task to identify at least one rate determinant of the thread task.

8. The method of claim 1, the identifying comprising: monitoring resources utilized during performance of the thread task.

9. The method of claim 1, comprising:
determining at least one rate determinant during a first performance a thread task, and
storing at least one rate determinant indicator associated with the thread task and determined during the first performance of the thread task; and the identifying comprising: retrieving at least one stored rate determinant indicator associated with the thread task.

10. A computer-readable medium comprising processor-executable instructions configured to perform a method of indicating a rate determinant of a thread task, the method comprising:
identifying at least one rate determinant of the thread task, and
associating with the thread task at least one rate determinant indicator representing one of the rate determinants of the thread task.

11. A method of assigning a scheduling priority to a thread task in a thread executing on a computer system, the method comprising:
identifying at least one rate determinant represented by at least one rate determinant indicator associated with the thread task,
detecting availability of the at least one rate determinant of the thread task, and
assigning the scheduling priority to the thread proportional to the availability of the at least one rate determinant.

12. The method of claim 11, the at least one rate determinant comprising at least one of a central processing unit, a graphics processing unit, a communications bus, a communications network, a device, and a second thread task.

13. The method of claim 11, comprising:
determining at least one rate determinant during a first performance a thread task, and
storing at least one rate determinant indicator associated with the thread task and determined during the first performance of the thread task; and the identifying comprising: retrieving at least one stored rate determinant indicator associated with the thread task.

14. The method of claim 13, comprising:
seeking an unallocated resource share of a resource comprising the rate determinant associated with the thread task; and
upon identifying an unallocated resource share, allocating the resource share to the thread task.

15. The method of claim 14, comprising:
upon identifying an unallocated resource share of a processor for a thread task having a processor rate determinant, assigning an affinity of a processor for the thread task.

16. The method of claim 14, comprising:
upon identifying an unallocated resource share of a processor comprising the rate determinant for a thread task, allocating at least two contiguous shares of the processor to the thread task.

17. The method of claim 14, comprising: upon detecting at least one of a completion, a failure, and a user termination of the thread task, deallocating the resource share allocated to the thread task.

18. The method of claim 14, comprising:
upon failing to identify an unallocated resource share of the resource, suspending the thread task; and
upon detecting availability of an unallocated resource share of the resource:
unsuspending a suspended thread task having a rate determinant associated with the resource, and
allocating the unallocated resource share to the unsuspended thread task.

19. The method of claim 18, comprising:
upon suspending a thread task, placing the thread task in a suspended thread task queue associated with the resource;
and the unsuspending comprising:
upon detecting availability of an unallocated resource share of the resource:
unsuspending a suspended thread task in the suspended thread task queue associated with the resource, and
removing the unsuspended thread task from the suspended thread task queue.

20. The method of claim 19, the thread tasks having an ordered priority indicator, and the suspended thread task queue comprising a priority queue based on the ordered priority indicator of the suspended thread tasks.
